(19) United States
(12) Patent Application Publication
(10) Pub. No.: US 2008/0235058 A1
(43) Pub. Date: Sep. 25, 2008

(54) VITAL SIGN MONITOR UTILIZING HISTORIC PATIENT DATA

(75) Inventors: Bruce A. Friedman, Tampa, FL (US); John W. Booth, Tampa, FL (US); Richard Medero, Tampa, FL (US); Lawrence T. Hersh, Tampa, FL (US); Sai Kolluri, Tampa, FL (US)

Correspondence Address: Andrus, Sceales, Starke & Sawall, LLP, 100 East Wisconsin Avenue, Suite 1100, Milwaukee, WI, 53202-4178, US

(73) Assignee: THE GENERAL ELECTRIC COMPANY, Schenectady, NY (US)

(21) Appl. No.: 12/133,922

(22) Filed: Jun. 5, 2008

Related U.S. Application Data
(63) Continuation-in-part of application No. 11/292,037, filed on Dec. 1, 2005.

(51) Int. Cl. G06Q 50/00

(52) U.S. Cl. 705/3

(57) ABSTRACT

A vital sign monitoring system that can be used with multiple patients and utilizes historic patient data information for the patient to optimize the process of obtaining current vital sign measurements. Each patient is identified with a unique patient identification device that is automatically detected by the vital sign monitor. The vital sign monitor communicates with a medical records database and obtains historic patient data information and previously diagnosed characteristics for the patient identified by the patient identification device. The historic patient data information and previously diagnosed characteristics of the patient can be utilized by the vital sign monitor to set alarm limits for the vital sign measurements and automatically adjust the blood pressure estimation algorithm of the NIBP monitor.

### CROSS-REFERENCE TO RELATED APPLICATION

This application is a continuation-in-part application of U.S. patent application Ser. No. 11/292,037, filed on Dec. 1, 2005.

### BACKGROUND OF THE INVENTION

The present disclosure generally relates to a vital sign monitor that can be used for collecting vital sign measurements, including non-invasive blood pressure readings, from one or more patients. More specifically, the present disclosure relates to a vital sign monitor that can obtain patient information for each patient and optimize the operation of the vital sign monitor based upon the patient information.

Blood pressure is a vital sign that is typically measured on patients in medical settings. Blood pressure readings are most often taken using non-invasive blood pressure cuffs attached to the upper arm of the patient. The cuff is operatively connected to a blood pressure monitor, which receives readings from the cuff, analyzes the readings using various predetermined algorithms, and displays measurement values associated with the blood pressure of the patient. The blood pressure measurements may be taken as part of more a comprehensive vital signal monitoring process that can also collect other important data from a patient, such as temperature and heart rate.

In many applications, the vital sign monitor is transported between multiple patients and the vital sign measurements taken from each patient are recorded by medical personnel. The measured vital sign data can be either automatically or manually entered into a hospital information system (HIS) such that the measurement data can be accessible by other personnel in the hospital and forms part of the patient's record.

Each time the vital sign monitor is utilized with a new patient, the blood pressure cuff is placed around the patient's arm and is inflated to an initial inflation pressure. Since the vital sign monitor is used with multiple patients, the monitor does not have access to any historic information regarding the patient. Thus, the vital sign monitor inflates the blood pressure cuff to a standard initial inflation pressure. In many cases, the initial inflation pressure will be well above the systolic pressure for the patient, thereby requiring the blood pressure cuff to be deflated in a series of steps prior to the cuff pressure reaching the systolic pressure. The over-inflation of the blood pressure cuff results in both patient discomfort and an increased amount of time required to take a blood pressure reading for the patient.

When the vital sign monitor is utilized with multiple patients, it is also difficult to provide alarm limits for the vital signs being obtained from each patient, since historic data for each of the patients is not readily available without the medical personnel consulting historic data charts at the patient's location. Thus, the use of a vital sign monitor that travels between multiple patients eliminates the ability to provide preset alarm limits for different vital signs based on the patient's condition, such as patient temperature or heart rate.

It is therefore desirable to provide a vital sign monitor that can utilize historic data for the patient to modify the operation of the vital sign monitor and set alarm limits for various vital sign parameters. It is further desirable to provide a vital sign monitor that can obtain information about a patient and adjust the blood pressure determination algorithm based upon the patient information.

### SUMMARY OF THE INVENTION

The following describes a method and apparatus for obtaining vital sign information from one or more patients utilizing a single vital sign monitoring device. Preferably, the vital sign monitoring device includes at least a non-invasive blood pressure (NIBP) monitoring system, as well as components for obtaining the temperature and heart rate from the patient. The blood pressure cuff of the NIBP monitoring system is selectively inflated and deflated. During the deflation of the blood pressure cuff from an initial, target inflation pressure, oscillometric pulses are detected and the processor within the vital sign monitor calculates the blood pressure based upon the oscillometric pulses.

The method and system for optimizing the operation of the vital sign monitor includes providing each patient with a unique patient identification device that can be read by the vital sign monitor. As an illustrated example, the patient identification device can include a bar code attached to the patient that can be automatically read by a bar code reader of the vital sign monitor. Alternatively, the patient's identification device can be an RF tag that can be detected by a RF detector included within the vital sign monitor.

Once the vital sign monitor has obtained the patient identification information from the patient, such as through the use of the bar code scanner, the vital sign monitor communicates with an electronic medical records database that includes historic information for the patient identified by the patient identification information. Preferably, the medical records database includes historic patient data measurements and other medically relevant information for the patient. This includes but is not limited to patient vital sign data, patient demographic data (e.g. weight, height, age, diagnosis, gender) and previously diagnosed characteristics of the patient. The historic measurements and medical information is uploaded into the vital sign monitor such that the vital sign monitor can optimize the operation of the vital sign measurement processes based upon the historic data.

Upon receiving the historic patient information, the vital sign monitor sets alarm limits for various vital sign parameters being obtained from the patient. As an example, maximum and minimum thresholds can be set for the patient's heart rate, oxygen saturation and temperature based upon reference values determined from past measurement cycles.

In addition to setting alarm limits, the vital sign monitor can automatically adjust the operation of the vitals sign monitor based upon measurements taken during preceding measurement cycles. Specifically, for blood pressure measurements the vital sign monitor can adjust the initial inflation pressure based upon the systolic pressure measured over several prior measurement cycles. The adjustment of the initial inflation pressure eliminates over-inflation of the pressure cuff and optimizes the blood pressure measurement cycle.

Once the initial inflation pressure has been adjusted based on patient-specific past measurements, the vital sign monitor inflates the blood pressure cuff to the initial inflation pressure. After the initial inflation pressure has been reached, the blood pressure cuff is deflated in a series of steps. During each step, oscillometric pulses are measured such that the NIBP monitoring system can determine the blood pressure for the patient.

The historic patient data could be used in a similar manner to change other features of the vital signs monitor, including but not limited to changing filter settings on the blood pressure or pulse oximeter monitors or adjusting analysis of vital sign measurements based on patient demographic data. As an example, based on patient demographic data and/or previously diagnosed characteristics for the patient, such as whether the patient is suffering from diabetes, is pregnant and suffering from pre-eclampsia or is suffering from peripheral artery disease (PAD), the vital signs monitor can adjust the blood pressure estimating algorithm to compensate for the changes in physical properties of the patient based upon the demographic data and/or the previously diagnosed characteristics of the patient.

Once the blood pressure and other vital signs have been obtained from the patient, the vital sign monitor communicates the current blood pressure readings and other vital sign measurements back to the medical records database such that the patient's records can be updated. After the vital signs from a patient have been measured, the vital sign monitor can be taken to another patient and the patient automatically identified. Once the patient is automatically identified, the vital sign monitor obtains historic information for the patient and optimizes the vital sign measurement cycle as described.

### BRIEF DESCRIPTION OF THE DRAWINGS

The drawings illustrate the best mode presently contemplated for carrying out the invention. In the drawings:

FIG. 1 is an illustrative view of the vital sign monitor having communication capability with a medical records database and a bar code reader used to identify a patient;

FIG. 2 illustrates oscillometric data, including step deflate and oscillation pulse amplitudes, derived using the NIBP monitor of the vital sign monitoring system shown in FIG. 1;

FIG. 3 illustrates a preferred method of operating the NIBP monitor utilizing historic patient data;

FIG. 4 is a flowchart illustrating one example of the steps utilized to obtain patient data from the medical records database and modifying the operation of the vital sign monitor; and

FIG. 5 is a flowchart illustrating the detailed operation of the NIBP monitor to adjust the blood pressure estimates based upon previously diagnosed characteristics of the patient.

### DETAILED DESCRIPTION OF THE INVENTION

In the embodiment of the invention described in detail below, an apparatus, system and method for collecting vital sign information from a plurality of patients is provided. It should be understood that the drawings and specification are to be considered an exemplification of the principles of the invention, which is more particularly defined in the appended claims. For example, although specific embodiments of the blood pressure cuff and vital sign monitor including non-invasive blood pressure monitoring capabilities are depicted in the figures, it will be recognized that different vital sign monitoring equipment can be utilized while employing the principles of the present invention. In addition, although the figures depict particular steps related to the method of the invention, it will be recognized that alternative, equivalent steps or procedures may be employed within the principles of the claimed invention.

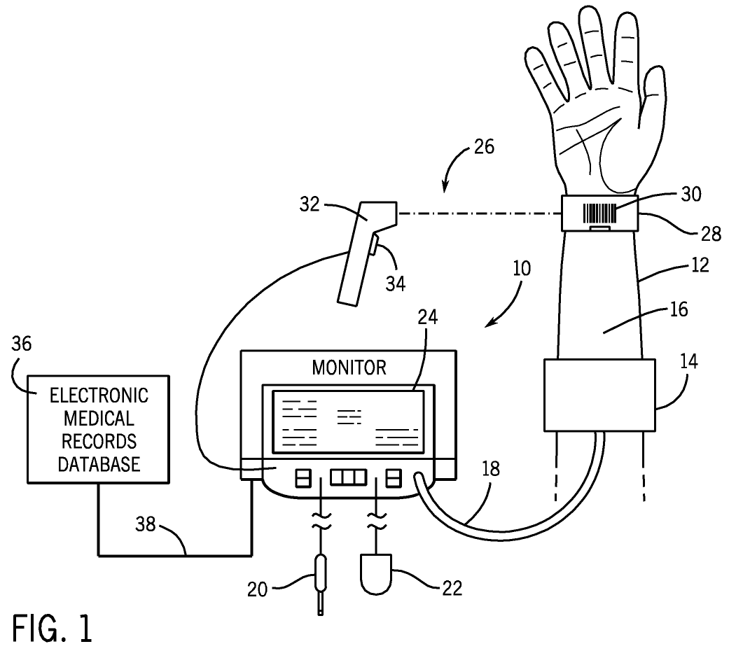

Referring first to FIG. 1, a vital sign monitor 10 is shown. The vital sign monitor 10 is preferably a mobile device that can be moved between multiple patients by medical personnel to obtain vital sign measurements from each of the patients. In the embodiment of the invention illustrated, the vital sign monitor 10 includes the ability to obtain vital sign measurements from a plurality of individual patients, such as blood pressure readings, temperature readings, heart rate and blood oxygen saturation from the patient 12.

As illustrated, the vital sign monitor 10 includes a blood pressure cuff 14 that can be placed on an arm 16 of the patient 12 to obtain blood pressure measurements in a manner to be described below. The blood pressure cuff 14 is connected to the vital sign monitor 10 by an air hose 18. The vital sign monitor 10 is coupled to a supply of pressurized air such that the vital sign monitor 10 can selectively inflate and deflate the pressure cuff 14 through the air hose 18.

In addition to the pressure cuff 14, the vital sign monitor 10 includes an electronic thermometer 20 for obtaining the patient temperature and a pulse oximeter probe 22 that is operable to obtain both heart rate and blood oxygen saturations from the patient. Preferably, vital sign monitor 10 includes a display 24 that visually presents the obtained vital sign information. The vital sign monitor 10 is automatically operable to obtain the blood pressure measurement, temperature, heart rate and blood oxygen saturation from the patient 12 once the blood pressure cuff 14, thermometer 20 and probe 22 have been placed on the patient. The operation of the vital sign monitor 10 to obtain this information is well known

In the embodiment of the invention illustrated in FIG. 1, the vital sign monitor 10 includes detection means 26 for providing patient identification information to the vital sign monitor 10. Specifically, the detection means includes the unique patient identification device 28 placed on each individual patient. In the specific embodiment illustrated in FIG. 1, the patient identification device 28 is a bracelet including a bar code 30. Although a pre-printed bar code 30 is shown in the illustrated embodiment, the patient identification device 28 could be a radio frequency tag or other means for uniquely identifying the patient 12.

In the illustrated embodiment, the detection means 26 also includes a bar code reader 32 coupled to the vital sign monitor 10. The bar code reader 32 can be actuated using trigger 34 to electronically read the bar code 30 attached to the patient 12. Since each patient includes a unique bar code 30, the bar code reader 32 can automatically and electronically identify the patient 12 and relay the identification information to the vital sign monitor 10 using either a hard-wired communication link or a wireless communication link between the vital sign monitor 10 and the bar code reader 32.

In the embodiment of the invention illustrated in FIG. 1, the vital sign monitor 10 is in communication with an electronic medical records database 36. As an example, the electronic medical records database can be part of a hospital information system (HIS) and configured to store historic patient data information for each patient within the hospital. The medical records database 36 can include not only vital sign information, but other medically relevant information relating to each of the patients. As an example, the medical records database 36 can include information relating to the patient's age, previously diagnosed characteristics of the patient, such as if the patient is diabetic, pregnant, pre-eclampsic or suffering from peripheral artery disease (PAD) and past treatment information.

In the embodiment of the invention illustrated in FIG. 1, the vital sign monitor 10 is in communication with the medical records database 36 over a communication link 38. The communication link 38 can be either a hard-wired communication link or a wireless communication link between the vital sign monitor 10 and the medical records database 36.

As described previously, the vital sign monitor 10 includes a non-invasive blood pressure (NIBP) monitor that controls the inflation and deflation of the pressure cuff 14 to obtain blood pressure information from the patient. Specifically, the blood pressure cuff 14 includes a transducer that is used to sense pressure oscillations in the cuff that are generated by pressure changes in the brachial artery under the blood pressure cuff 14. The electrical signals from the pressure transducer are obtained by the vital sign monitor 10 and are used by well-known algorithms operating in the vital sign monitor 10 to calculate the patient's blood pressure.

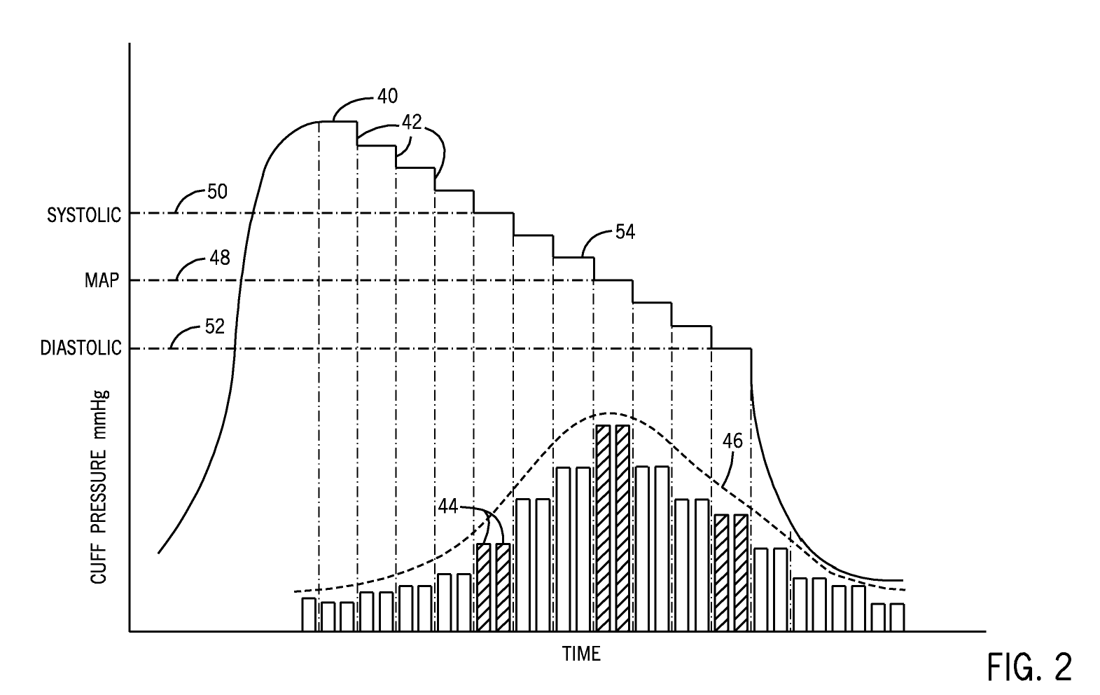

During normal operation of the vital sign monitor 10, the blood pressure cuff 14 is placed on the patient 12, typically around the patient's arm 16 over the brachial artery. At the inception of the measuring cycle, the blood pressure cuff 14 is inflated to an initial inflation pressure that fully occludes the brachial artery, i.e., prevents blood from flowing through the brachial at any point in the heart's cycle. In FIG. 2, the initial inflation pressure is illustrated by reference numeral 40.

After the blood pressure cuff has been inflated to the initial inflation pressure 40, the pressure cuff is deflated in a series of pressure steps 42. After each pressure step 42, the NIBP monitoring system detects and records one or more pressure oscillations 44 for the current cuff pressure. The pressure transducer measures the internal cuff pressure and provides an analog signal characterizing the blood pressure oscillations. The peak values of the complex signals are determined within the vital sign monitor.

As the measurement cycles progress, the peak amplitude of the blood pressure complexes generally become monotonically larger to a maximum and then become monotonically smaller as the cuff pressure continues toward full deflation, as illustrated by the general bell curve 46 in FIG. 2. The oscillometric measurements are used by an algorithm operating within the vital sign monitor to calculate the mean arterial pressure (MAP) 48, the systolic pressure 50 and the diastolic pressure 52 in a known manner.

As can be understood in FIG. 2, the initial inflation pressure 40 for the blood pressure cuff must exceed the systolic pressure 50 for the system and method of NIBP monitoring to function effectively. In past embodiments of a vital sign monitor that can be used with multiple patients, the initial inflation pressure 40 is a standard value. Since the vital sign monitor is utilized with multiple patients, the initial inflation pressure 40 is selected such that the initial inflation pressure 40 will be above the typical systolic pressure 50 for most patients. Typically, the initial inflation pressure 40 is selected at a relatively high value such that it will exceed the systolic pressure 50 for most patients.

FIG. 2 illustrates an embodiment in which the initial inflation pressure 40 is significantly higher than the systolic pressure 50 for the particular patient. In this operational example, the pressure within the blood pressure cuff must be decreased a significant number of pressure steps 42 before the cuff pressure 54 reaches the systolic pressure 50. The over inflation of the blood pressure cuff results in the patient experiencing discomfort due to unnecessarily high cuff pressures and prolonged occlusion of the brachial artery. Further, the over inflation of the blood pressure cuff increases the overall time required to take a blood pressure reading from the patient due to the numerous pressure steps 42 required before the cuff pressure reaches the systolic pressure 48.

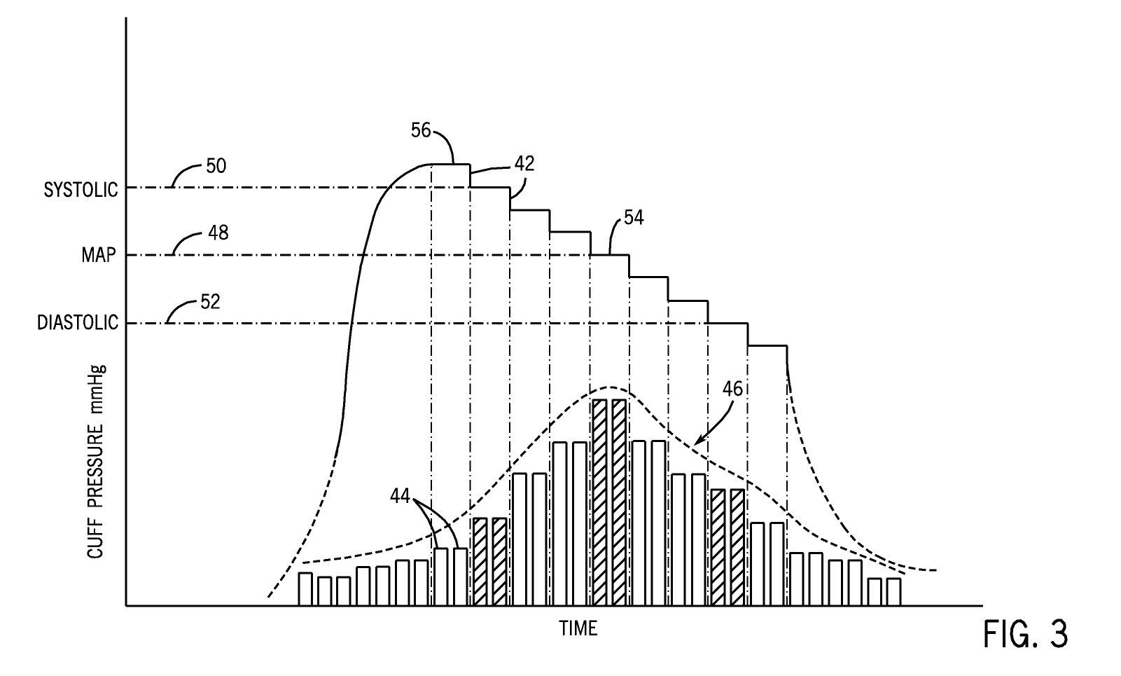

Referring now to FIG. 3, thereshown is a preferred method of operating the NIBP system in accordance with the present invention. As illustrated, the initial inflation pressure 56 is selected much closer to the systolic pressure 50 for the patient such that only a single pressure step 42 is required to deflate the cuff pressure 54 to the systolic pressure 50. In this embodiment, the cuff is no longer over-inflated and the time required to obtain the blood pressure measurements has been decreased.

In order to achieve the optimized inflation pressure 56 shown in FIG. 3, the vital sign monitor 10 calculates the initial inflation pressure for the specific patient based upon historic blood pressure measurements taken for the patient 12 that are stored in the medical records database 36 shown in FIG. 1. Specifically, the vital sign monitor 10 accesses the stored historic patient data measurements from the medical records database 36 for the specific patient and utilizes an algorithm to select the initial inflation pressure such that the initial inflation pressure is based upon the historical vital sign information obtained from the patient, rather than a standard inflation pressure utilized for all patients.

In addition to optimizing the initial inflation pressure, the vital sign monitor 10 of the present invention utilizes additional historic patient data information obtained from the medical records database 36 to set alarm parameters and tailor the operation of the vital sign monitor 10 for the specific patient 12.

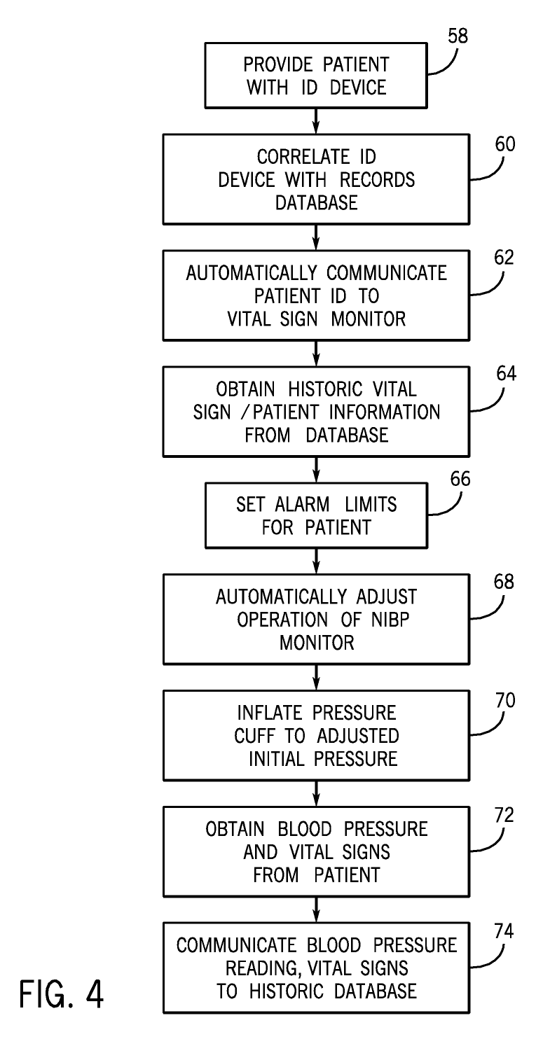

The operation of the vital sign monitor 10 will be described with reference to FIG. 4. Initially, each individual patient is provided with a unique, patient identification device in step 58. As described previously, the patient shown in FIG. 1 is provided with an identification bracelet having a unique bar code 30. However, other patient identification devices, such as an RF tags, can be utilized while operating within the scope of the present invention.

Once the patient has been given an identification device, the identification device is correlated with patient records stored in the medical records database 36, as indicated in step 60. The correlation of the patient identification device with the patient's record in the medical records database allows patient information to be retrieved from the database and utilized by the vital sign monitor 10.

After each patient has been assigned a patient identification device, the patient identification information from the patient identification device is automatically communicated to the vital sign monitor in step 62. In the embodiment of the invention illustrated in FIG. 1, the patient identification information is included on a bar code 30 and is read by the bar code reader 32. However, other automatic methods of obtaining patient identification information are contemplated as being within the scope of the present invention.

Referring back to FIG. 4, after the patient identification information has been obtained by the vital sign monitor 10, the vital sign monitor communicates to the medical records database 36 to obtain historic patient data measurements and patient information from the medical records database 36, as illustrated in step 64. The historic data stored in the electronic medical records database 36 can include information relating to the past measurements obtained by the vital sign monitor 10. This information can include past blood pressure readings, past heart rate measurements, past patient temperatures and other information that may be related to the steps required to obtain the vital sign information from the patient.

In addition to the past vital sign measurements, other relevant patient demographic information, such as the patient's age, medical condition, weight or other similar information can be obtained by the vital sign monitor in step 64. In addition to the patient demographic information, the vital sign monitor can retrieve previously diagnosed characteristics of the patient from the medical records database. The previously diagnosed characteristics of the patient may include, but is not limited to, whether the patient is suffering from diabetes, is pregnant, is suffering from pre-eclampsia, or is suffering from peripheral arterial disease (PAD). Each of these previously diagnosed characteristics has been shown to stiffen the arteries of a patient, which may affect the accuracy of the standard NIBP monitoring algorithm. As previously indicated, the vital sign monitor 10 can obtain the information from the medical records database using either a wired or wireless communication link.

Since the vital sign monitor 10 is contemplated as being used with multiple different patients, the vital sign monitor 10 can obtain patient-specific information from the medical records database 36 and utilize the patient-specific information to optimize the steps required to obtain the vital signs from the patient. When the vital sign monitor 10 is moved to the next patient, patient-specific vital sign information can be obtained from the medical records database and utilized to optimize the vital sign measurement for the next patient.

Referring back to FIG. 4, once the historic information is received for the specific patient being monitored by the vital sign monitor, internal algorithms within the vital sign monitor can be used to set alarm limits for the specific patient, as illustrated in step 66. As an example, based upon the most recent heart rate measurements obtained for the patient, the algorithm within the vital sign monitor can set alarm limits for the heart rate based upon threshold levels both above and below the most recent measurements. Since heart rate is dependent upon the physical state, age and weight of the patient, the algorithm can use these other parameters, along with past measurements, obtained from the medical records database to set alarm limits for the patient. Further, since the medical diagnosis for the patient also affects acceptable heart rate levels, this information can also be used to set the alarm limits in step 66.

In step 68, the vital sign monitor 10 automatically adjusts the operation of the NIBP monitoring components to control the inflation/deflation of the pressure cuff 14. As discussed previously, it is highly desirable to select the initial inflation pressure for the blood pressure cuff based upon past blood pressure measurements for the patient. Specifically, it is desirable to select the initial inflation pressure as close to the systolic pressure as possible to avoid over inflation and to decrease the amount of time required to obtain a blood pressure measurement.

When selecting the initial inflation pressure, the vital sign monitor utilizes an algorithm that estimates the systolic pressure of the patient based upon at least one past measurement. Since the initial inflation pressure must be above the systolic pressure for proper operation of the NIBP monitoring system, the initial inflation pressure is selected a determined amount above the predicted systolic pressure for the patient. As can be understood, selecting the initial inflation pressure for the specific patient is a vast improvement over prior art systems that select the same initial inflation pressure for each patient.

As illustrated in step 70, the vital sign monitor inflates the pressure cuff to the adjusted initial inflation pressure. After the blood pressure cuff has been inflated to the initial inflation pressure, the cuff is deflated in the series of pressure steps to obtain the oscillometric information required to calculate the blood pressure for the patient. At the same time, the vital sign monitor 10 can also obtain other vital sign information from the patient, as illustrated in step 72. It is contemplated that the other vital sign information obtained by the vital sign monitor may include heart rate, temperature, blood-oxygen saturation and any other parameters that may be useful in monitoring a patient.

In addition to utilizing the historic patient data measurements to adjust the initial inflation pressure, the vital sign monitor can also utilize the historic patient data measurements and previously diagnosed characteristics of the patient to modify the algorithm utilized to calculate the blood pressure for the patient based upon the oscillations received from the blood pressure cuff. As an example, the NIBP algorithm used to calculate blood pressure may be adjusted based upon the patient's age or the disease state of the patient.

In typical NIBP monitoring systems that utilize the detected pressure oscillations from the blood pressure cuff to calculate the systolic pressure and the diastolic pressure, the systolic and diastolic pressure estimates are estimated based upon the maximum amplitude of the pressure oscillations, which is referred to as the mean arterial pressure (MAP). When utilizing a standard NIBP algorithm, once the MAP has been calculated, the systolic pressure is estimated as a ratio of the MAP. As an example, the systolic pressure is determined to be the cuff pressure at the detected pressure oscillation having an amplitude of one-half the maximum pressure oscillation. Likewise, the diastolic pressure is determined to be the cuff pressure past the peak oscillation at which the amplitude of the pressure oscillation is ⅝ the value of the maximum pressure oscillation. The use of these two ratios to estimate the systolic and diastolic pressure based upon the detected MAP provides a typically very accurate blood pressure estimation for normotensive patients.

In the normal operation of an NIBP monitor using oscillometric methods of measuring the blood pressure, the pressure transducer within the pressure cuff receives signals from the blood pressure cuff that are, in part, based upon the physical characteristics of the arteries within the patient being monitored. The blood vessels within the patient function as a pressure sensor in transferring pressure pulses that relate to the blood pressure in the patient. If the physical characteristics of the blood vessels within the patient are altered, such as due to diabetes, pregnancy, pre-eclampsia or PAD, the pressure pulses detected by the pressure transducer are altered as compared to the those from a normotensive patient. Since the normal physical characteristics of the patient's blood vessels change during these types of diagnosed conditions of a patient, the normal algorithm used to estimate the systolic and diastolic blood pressures may be inaccurate. Typically, the blood pressure estimates determined for those patients utilizing a typical algorithm from an NIBP monitor result in systolic and diastolic pressure estimates that are slightly lower than the systolic blood pressure and diastolic blood pressure measurements made by a physician utilizing manual measurement techniques, such as with a blood pressure cuff and a stethoscope. Since physicians typically treat patients based upon these manual measurements, the use of the typical NIBP monitoring algorithm for patients suffering from one of the previously diagnosed characteristics identified above may result in lower blood pressure estimates, thus causing an altered course of treatment.

For the previously diagnosed characteristics of the patient set forth above, each of the characteristics, such as diabetes, pregnancy, pre-eclampsia and PAD has the result in stiffening of the patient arteries, which results in reduced oscillations received from the patient as compared to oscillations received from a healthy patient having the same blood pressure. Alternatively, it is contemplated that other previously diagnosed characteristics of the patient may result in increased compliance of the blood vessels, therefore resulting in oscillations having an increased value as compared to those from a healthy patient.

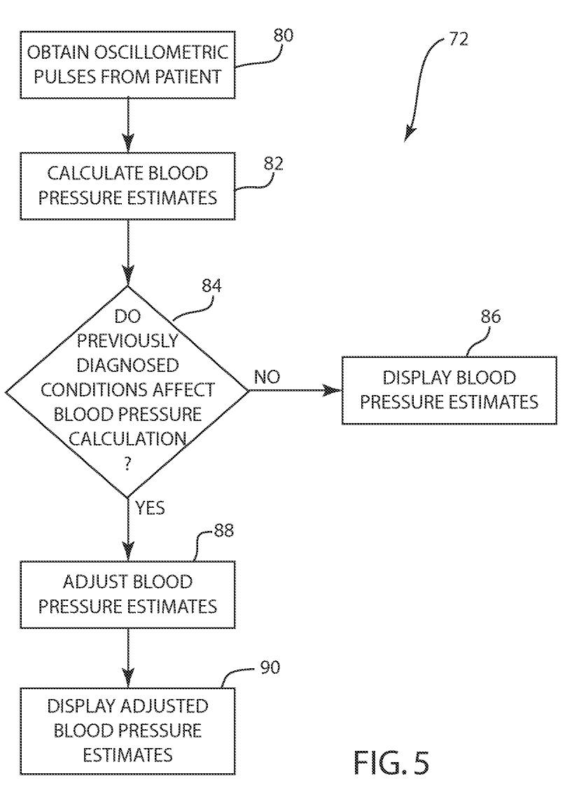

FIG. 5 provides additional details of step 72 from FIG. 4. As illustrated in FIG. 5, the NIBP monitoring system initially obtains the oscillometric pulses from the patient in step 80 and calculates a blood pressure estimate utilizing the standard NIBP algorithm in step 82. As indicated previously, a conventional algorithm used in many NIBP monitoring systems determines the systolic and diastolic pressure based upon a ratio of the maximum amplitude that corresponds to the mean arterial pressure (MAP).

Once the processor of the NIBP monitoring system has calculated the blood pressure estimates in step 82, the processor then determines in step 84 whether the patient has a previously diagnosed characteristic, obtained from the historic patient database in step 64, which may affect the blood pressure calculation. As indicated above, several of these previously diagnosed characteristics include diabetes, pregnancy, pre-eclampsia or PAD. Although these characteristics are described in the present disclosure, it is contemplated that various other characteristics could affect the blood pressure estimate calculated utilizing a standard NIBP algorithm.

If the processor determines in step 84 that the patient is not suffering from one of the previously diagnosed characteristics that affect the blood pressure calculation, the processor displays the blood pressure estimates in step 86. Once the blood pressure estimates have been displayed in step 86, the system returns to step 74 in FIG. 4.

If, however, the processor determines in step 84 that the patient is suffering from one or more of the previously diagnosed characteristics that affect the blood pressure calculation, the system then adjusts the blood pressure estimates in step 88. As one example, if the patient is suffering from diabetes, the blood pressure estimates calculated in step 82 may be low for both the systolic and diastolic pressure estimates as compared to the blood pressure manually determined by a physician using a blood pressure cuff and stethoscope. Thus, in accordance with the method shown, the processor adjusts the algorithm used to determine the blood pressure estimates such that the blood pressure estimates more accurately correspond to manual blood pressure measurements taken by a physician utilizing a manual inflatable blood pressure cuff and stethoscope.

Various different methods are contemplated within the scope of the present disclosure to adjust the blood pressure estimates in step 88. Several presently contemplated methods are set forth below as illustrative examples but are not meant to provide an exhaustive listing of all the different types of methods that could be contemplated as being within the scope of the present disclosure.

A first contemplated method of adjusting the blood pressure estimates in step 88 is to add a fixed offset to the estimated systolic, diastolic and MAP pressure values. The fixed offsets can be determined utilizing historic data values comparing the blood pressure estimates generated by the NIBP monitoring algorithm for patients suffering from the previously diagnosed characteristic to those determined by a physician utilizing a manually inflatable blood pressure cuff and stethoscope. Based upon these historic values, fixed offsets can be determined and added to the systolic, diastolic and MAP pressures.

In a second, alternate method of adjusting the blood pressure estimates in step 88, the processor of the NIBP monitoring system can add offsets to the calculated blood pressure estimates that are dependent upon the value of a measured systolic, diastolic or MAP pressure value. As an examples, the adjusted systolic pressure may be calculated as 125% of the calculated systolic pressure estimate. Likewise, the adjusted diastolic pressure may be selected at 125% of the diastolic pressure previously determined. In this method, the amount of offset is dependent upon the calculated blood pressure estimates and the amount offset will vary depending upon the measured blood pressure from the patient.

In a third contemplated method of adjusting the blood pressure estimates, the processor of the NIBP monitoring system may adjust the amplitude ratios used to determine systolic and diastolic pressure. As an example, the oscillation amplitude ratios of the systolic pressure and the diastolic pressure to oscillation amplitude at the MAP may be adjusted based upon the previously diagnosed characteristic that affects the patient.

As a fourth alternative method, offsets are added to the blood pressure estimates based upon the measured pulse pressure at the systolic and diastolic values. Since the oscillation pulses are the physical characteristics actually measured by the NIBP monitoring system, adding an offset to the pulse pressure allows the system to compensate the actual physical measurements taken by the system rather than modifying the calculations determined by the system.

In each of the alternate methods described above, once the adjusted blood pressure estimates are calculated in step 88, the adjusted blood pressure estimates are displayed in step 90. Following the display of the blood pressure estimates either in step 86 or step 90, the system returns to the main operational flowchart shown in FIG. 4.

As the blood pressure and vital sign information is obtained from the patient, the vital sign monitor compares the vital sign information to the alarm limit set in step 66. If the vital sign information exceeds the alarm limits, an alarm can be generated to immediately indicate to medical personnel that the patient has significantly deviated from past medical readings. Since the vital sign monitor 10 is utilized with multiple patients, the ability to automatically set alarm limits for the specific patient based upon historic information from that specific patient provides additional benefits to medical personnel who are often required to monitor numerous patients during a given day.

As illustrated in FIG. 4, once the blood pressure reading and vital signs have been collected by the vital sign monitor, this current information is communicated to the electronic medical records database existing at the respective hospital or healthcare setting. Such information can be provided in real time and is useful in updating patient records and providing up-to-the-minute information to caregivers throughout the hospital. This is illustratively shown in step 74. The updated information is then utilized by the vital sign monitor the next time the vital signs for a new patient are measured.

It is important to note that different vital sign monitors can be utilized with the plurality of patients, since the vital sign monitor contacts the electronic medical records database to obtain historic information. Thus, since the patient information is not stored locally on the vital sign monitor and instead is stored at an accessible, remote location, different vital sign monitors can be utilized for monitoring the plurality of patients.

In the embodiment of the invention illustrated in FIG. 1, the medical records database 36 is shown located remotely from the vital sign monitor 10. As an example, the medical records database 36 may be the HIS system for the facility in which the patients are located. In the embodiment illustrated, the vital sign monitor 10 communicates to the medical records database 36 utilizing either a hard wire or wireless communication technique.

It is contemplated that the vital sign monitor 10 could include a limited medical records database within the physical housing of the vital sign monitor. If the medical records database is included within the actual vital sign monitor, the vital sign monitor would no longer need to contact the remotely located medical records database.

In a vital sign monitor including an internal medical records database, a patient record would be established for each patient during the initial vital sign measurement cycle. Each time the vital sign monitor is used with the same patient, the patient identification information received from the patient would be utilized to retrieve historic information stored within the internal medical records database. Since the internal database contained within the vital sign monitor would have limited storage capabilities, once a patient has been discharged or is no longer being monitored, that patient's information would be removed from the internal medical records database. The vital sign monitor 10 including an internal medical records database is contemplated as being particularly useful in small facilities that do not include any central medical records database. The internal medical records database would allow the vital sign monitor 10 to utilize past measurements from the patient to optimize the procedures required to obtain current vital sign measurements from the patient.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Various alternatives and embodiment are contemplated as being within the scope of the following claims particularly pointing out and distinctly claiming the subject matter regarded as the invention.

We claim:

1. A method of enhancing the operation of a vital sign monitor having a blood pressure cuff selectively inflatable and deflatable to determine a blood pressure estimate for a patient, the method comprising the steps of:
obtaining patient identification information for the patient;
electronically communicating with a medical records database that includes stored, previously diagnosed characteristics for the patient;
retrieving the previously diagnosed characteristics for the patient based upon the obtained patient identification information;
determining whether the previously diagnosed characteristics for the patient affect the blood pressure estimate for the patient;
operating the vital sign monitor to estimate the blood pressure of the patient utilizing an estimation algorithm; and
adjusting the blood pressure estimate for the patient when the previously diagnosed characteristics for the patient affect the blood pressure estimate.

2. The method of claim 1 wherein the step of adjusting the blood pressure estimate comprises adjusting the estimation algorithm.

3. The method of claim 2 wherein the step of adjusting the estimation algorithm comprises:
adjusting the oscillation amplitude ratio used to estimate a systolic pressure from the oscillation amplitude at the estimated mean arterial pressure; and
adjusting the oscillation amplitude ratio used to determine a diastolic pressure from the oscillation amplitude at the mean arterial pressure.

4. The method of claim 2 wherein the step of adjusting the estimation algorithm comprises:
increasing an estimated systolic pressure by a first offset value when the patient has a previously diagnosed characteristic that affects the blood pressure estimate; and
increasing an estimated diastolic pressure by a second offset value when the patient is suffering from a previously diagnosed characteristic that affects the blood pressure estimate.

5. The method of claim 1 wherein the step of determining whether the previously diagnosed characteristics for the patient affect the blood pressure estimate includes determining whether the patient diabetic, is pregnant, is pre-eclamptic or has peripheral arterial disease.

6. The method of claim 1 further comprising the steps of:
retrieving historical patient data information for the patient based on the obtained patient identification information;
adjusting the operation of the vital sign monitor based upon the historic patient data information for the patient to obtain current vital sign measurements for the patient.

7. The method of claim 6 wherein an initial inflation pressure for the blood pressure cuff is determined based upon the retrieved historic patient data information for the patient.

8. The method of claim 7 further comprising the steps of:
setting alarm parameters for at least one vital sign measurement to be obtained from the patient based upon the retrieved historic patient data measurement for the patient;
operating the vital sign monitor to obtain the current vital sign measurements for the patient; and
activating an alarm when the obtained vital sign measurement exceeds the alarm parameters.

9. The method of claim 1 further comprising the step of transferring the adjusted blood pressure estimates from the vital sign monitor to the medical records database.

10. The method of claim 1 further comprising the steps of:
retrieving patient demographic information for the patient;
determining whether the patient demographic information affects the blood pressure estimate for the patient; and
adjusting the blood pressure estimate for the patient when the patient demographic information affects the blood pressure estimate.

11. A method of enhancing the operation of a vital sign monitor having a blood pressure cuff selectively inflatable and deflatable to determine a blood pressure estimate for a patient, the method comprising the steps of:
obtaining previously diagnosed characteristics for the patient;
determining whether the previously diagnosed characteristics for the patient affect the blood pressure estimate for the patient;
operating the vital sign monitor to determine the blood pressure estimate for the patient utilizing an estimation algorithm; and
adjusting the blood pressure estimate for the patient when the previously diagnosed characteristics for the patient affect the blood pressure estimate.

12. The method of claim 11 further comprising the steps of:
retrieving patient demographic information for the patient;
determining whether the patient demographic information affects the blood pressure estimate for the patient; and
adjusting the blood pressure estimate for the patient when the patient demographic information affects the blood pressure estimate.

13. The method of claim 11 further comprising the steps of:
retrieving historic patient data information for the patient; and
controlling the operation of the vital sign monitor based upon the historic patient data information to obtain current vital sign measurements for the patient.

14. The method of claim 13 wherein an initial inflation pressure of the blood pressure cuff is determined based upon the retrieved historic patient data information for the patient.

15. The method of claim 11 wherein the previously diagnosed characteristics for the patient are retrieved from a medical records database located remotely from the vital sign monitor.

16. The method of claim 11 wherein the previously diagnosed characteristics for the patient are obtained at the vital sign monitor.

17. The method of claim 11 wherein the step of adjusting the blood pressure estimate includes modifying the estimation algorithm used to determine the blood pressure estimate.

18. The method of claim 17 wherein the step of adjusting the estimation algorithm comprises:
adjusting the oscillation amplitude ratio used to estimate a systolic pressure from the oscillation amplitude at the estimated mean arterial pressure; and
adjusting the oscillation amplitude ratio used to determine a diastolic pressure from the oscillation amplitude at the mean arterial pressure.

19. The method of claim 17 wherein the step of adjusting the estimation algorithm comprises:
increasing an estimated systolic pressure by a first offset value when the patient has a previously diagnosed characteristic that affects the blood pressure estimate; and
increasing an estimated diastolic pressure by a second offset value when the patient is suffering from a previously diagnosed characteristic that affects the blood pressure estimate.
